(19) United States
(12) Patent Application Publication
(10) Pub. No.: US 2010/0051460 A1
(43) Pub. Date: Mar. 4, 2010

(54) MICROFLUIDIC SAMPLE DETECTION

(75) Inventors: Sunghoon Kwon, Seoul (KR); Seung Ah Lee, Seoul (KR)

Correspondence Address: Sunghoon Kwon;Faculty APT 1221-104, San 402, Bongchun 7 Dong, Gwanak-Gu, Seoul, KR

(73) Assignee: Seoul National University Industry Foundation

(21) Appl. No.: 12/199,268

(22) Filed: Aug. 27, 2008

(51) Int. Cl. G01N 27/26; B01J 19/00; C40B 40/00

(52) U.S. Cl. 204/451; 422/68.1; 506/13

(57) ABSTRACT

Disclosed is a method for sample detection by providing one or more samples to a microfluidic device including one or more microfluidic channels; and controlling one or more droplets in the channels to increase a likelihood of association between the one or more samples and one or more probes.

### BACKGROUND

In current DNA chip technology based on DNA-array-patterning substrates, a DNA sample is introduced to a chip that can be hybridized with a probe DNA fixed on a surface of a solid surface of the chip so that base sequencing can be obtained for the sample. The reaction speed of this hybridization process depends on the diffusion degree of DNA (or protein) molecules.

If the molecular diffusion is limited to a region near the surface of the substrate, the speed of the process is slower. Although analysis time can be reduced by increasing the density of the sample DNA within the sample, a viable analysis device has to be able to detect DNA at a range of densities or concentrations, even at a low density (i.e. concentration) of the sample DNA.

Since the time for analyzing a sample with a DNA or protein chip, including a target sample, typically takes several hours, a reduction in the analysis time as well detection sensitivity would be advantageous.

### SUMMARY

In one aspect, a method is provided for hybridizing a sample and a probe in a microfluidic device. In some embodiments, the method is for hybridizing a sample and a probe, in which a droplet formed within a microfluidic channel of the microfluidic device is controlled so that the reactivity between the sample and the probe is increased.

In another aspect, a method is provided for sample detection, including providing one or more samples to one or more microfluidic channels, where the microfluidic channel includes one or more droplets and one or more probes associated with one or more internal walls of the one or more microfluidic channels; and controlling the one or more droplets to increase a likelihood of association between the one or more samples and the one or more probes.

In some embodiments, the one or more microfluidic channels include at least one two-phase interface with respect to a surface of the droplet. The two-phase interface may include, but is not limited to, an air-liquid interface or a water-oil interface.

In some embodiments, a droplet is formed within a microfluidic channel by application of an external pressure to a microfluidic channel having a junction structure, or by application of thermo-capillary motion or electro-capillary motion into the microfluidic channel. In other embodiments, the droplet is controlled a desired size or speed by controlling geometry of a microfluidic channel.

In some embodiments, the microfluidic channel includes a droplet-based microfluidic channel. For example, a digital microfluidic device may be used as a microfluidic device, including such a droplet-based microfluidic channel.

In some embodiments, the microfluidic device, including the microfluidic channel includes, a micro-array with probes deposited on an internal wall of the microfluidic channel. In some embodiments, a likelihood of association between a sample and a probe within a microfluidic channel has a maximized value at the two-phase interface.

In some embodiments, the probe is one or more biological molecules, such as a nucleic acid or a protein.

In another aspect, one or more microfluidic devices are provided, which include a microfluidic channel including one or more droplets, a probe bound to an internal wall of the microfluidic channel; and a controlling means for controlling droplet formation within the microfluidic channel to increase a likelihood of association between a sample and a probe.

In some embodiments, the controlling means controls the droplet formation by application of an external pressure to the microfluidic channel having a junction structure. In some embodiments, the microfluidic device further includes an input port connected to the controlling means to introduce a sample, and to supply air into the microfluidic channel. In some embodiments, the microfluidic channel has a T-shape or cross-shape.

In another aspect, one or more DNA or protein chips are provided, which include the microfluidic channel as described above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a “coffee-ring” effect at an interface of a droplet forming a two-phase interface, according to one illustrative embodiment.

FIG. 2A is a schematic of a view of an illustrative embodiment of a microfluidics device in which a method for sample detection is performed.

FIG. 2B is an enlarged schematic view of an illustrative embodiment of a portion of a microfluidic channel of the microfluidics device of FIG. 2A.

FIG. 2C is a partial cross section of an illustrative embodiment of the microfluidic channel of FIG. 2B.

FIG. 2D is a schematic view of an illustrative embodiment of a T-shaped microfluidic channel, according to another embodiment.

FIG. 2E is a schematic view of an illustrative embodiment of a cross-shaped microfluidic channel, according to another embodiment.

FIG. 3A is a sectional view of an illustrative embodiment of the microfluidic channel for illustrating movement routes of samples flowing within the microfluidic channel of FIG. 2B.

FIG. 3B is a top view of an illustrative embodiment of the microfluidic channel for illustrating movement routes of samples flowing within the microfluidic channel of FIG. 2B.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In one aspect, a method is provided for sample detection. In some embodiments, such methods include, providing one or more samples to one or more microfluidic channels. The one or more microfluidic channels may include, but are not limited to one or more droplets and one or more probes associated with one or more internal walls of the one or more microfluidic channels. The methods may also include controlling the one or more droplets to increase a likelihood of association between the one or more samples and the one or more probes.

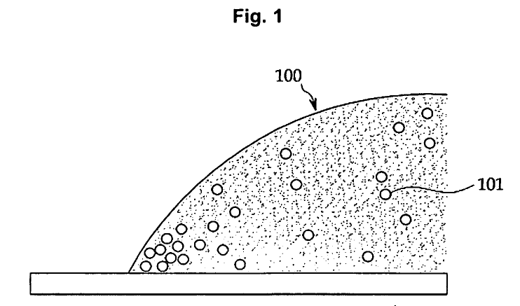

Referring now to the figures, FIG. 1 is a view illustrating a “coffee-ring” effect at an interface of a droplet 100. The droplet 100, as shown in FIG. 1, forms a two-phase interface. For example, the two-phase interface may be, but is not limited to, an air-liquid interface, or a water-oil interface. Particles 101 in the droplet 100 have a tendency to gather along a peripheral part of the droplet 100. Accordingly, partial concentration at the two-phase interface, for example, at the interface of the droplet 100 and air, is increased. This coffee-ring effect may be used in a microfluidic channel through which a solution including biological molecules, such as DNA, flows.

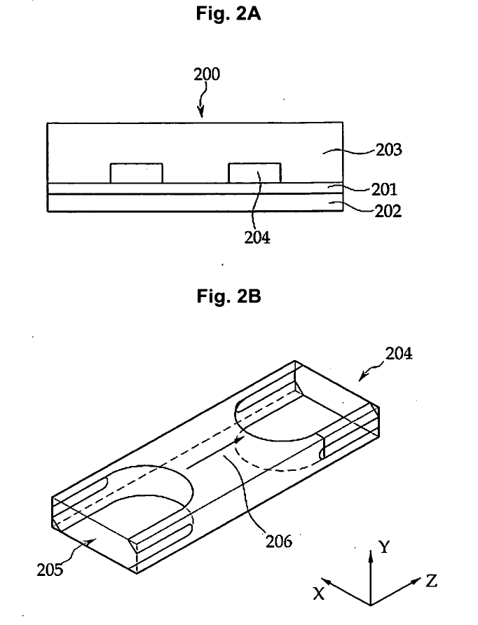

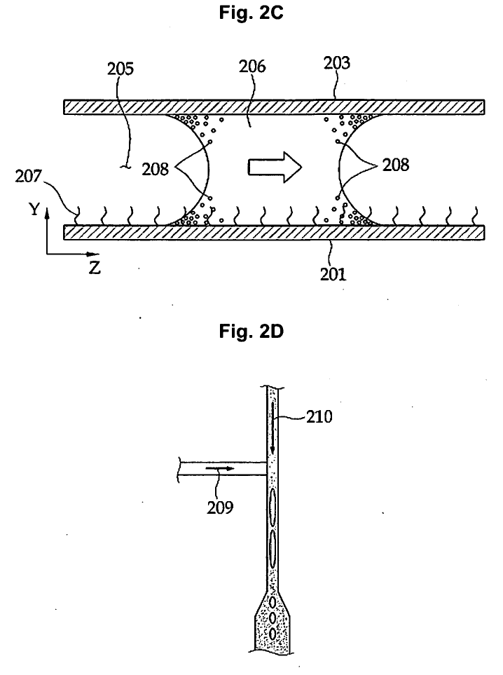

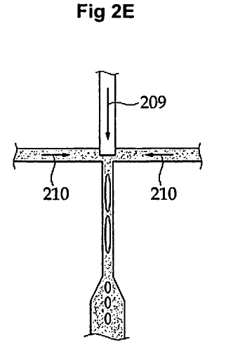

A method for sample detection is now described with reference to FIGS. 2A and 2B. FIG. 2A is a schematic view of a microfluidics device in which a method for sample detection is performed, according to one embodiment. FIG. 2B is an enlarged schematic view of a portion of a microfluidic channel of the microfluidics device of FIG. 2A. The microfludics device 200, is a continuous-flow microfluidics device. In the present disclosure, the phrase “continuous-flow microfluidics device,” refers to a microfluidics device in which continuous liquid flow is manipulated through microfabricated channels having a closed type structure. As described below, a droplet may be formed by controlling the continuous fluid flow through a microfluidic channel. Alternatively, although not shown in the figures, a digital microfluidics device may be used for sample detection. In the present disclosure, the phrase “digital microfluidics device” refers to a microfluidics device having open structures, and where discrete, independently controllable droplets are manipulated on a substrate. One of skilled in the art will understand the same method for sample detection, can be employed to both the continuous-flow microfluidics devices and to digital microfluidics devices.

In some embodiments, the microfluidics device 200 may include one or more closed types of microfluidic channels 204. The microfluidics device 200 may include, but is not limited to, a micro-array, such as a DNA chip or a protein chip, and wafers disposed on the top and the bottom of the micro-array, and coupled at both ends of the wafers.

The wafers may include, but are not limited to, silicon wafers or glass wafers. In some embodiments, the micro-array is formed by preparing a silicon wafer 210 having a solid substrate, attaching a flat glass wafer 202 to one side (i.e. the bottom) of the silicon wafer 201, and attaching an upper glass wafer 203 to the other side (i.e. the top) of the silicon wafer 201. An access hole 204 may be formed in the upper glass wafer 203, prior to attaching the wafer 203 to the silicon wafer 201. Access holes 204 may be made via a sand blasting process, etching process, or drilling process as are known to those of skill in the art. Through the access hole 204, that is, a channel, a liquid may flow. Alternatively, the upper glass wafer 203 may be formed by molding polymeric thermosetting materials such as PDMS and then hardening the materials though a soft lithography method.

Alternatively, a silicon wafer may be used in the micro-array, instead of the glass wafers 202 and 203.

In some embodiments, a solution including a sample is injected into the channel 204. The sample may include, but is not limited to, a biological molecules such as a cDNA, a cRNA, a mRNA, a recombinant DNA, and various types of antibodies, etc. The solution may include, but is not limited to, water, an alcohol, or a polyalkylene glycol, or other biologically compatible solvent. In some embodiments, a probe is provided to the solid substrate of the silicon wafer 201 through a patterning process. Any known patterning process may be used for locating the probes to the silicon wafer. The probe may include, but is not limited to, a biological molecule such as a cDNA, a cRNA, a mRNA, a recombinant DNA, and various types of antibodies, etc.

Referring to FIG. 2B, the sample solution passes through the microfluidic channel 204 while forming a droplet 206. The droplet 206 forms a two-phase interface. As used herein, the phrase “two-phase interface,” refers to the interface located between two immiscible phases, for example, air and a liquid, or water and an oil. In FIG. 2B, the two-phase interface is formed between air 205 and one side of the droplet 206. An arrow shows the movement direction of the droplet 206.

The droplet 206, having a two-phase interface, may be formed by applying an external pressure to the microfluidic channel 204 by delivering fluid and supplying air into the channel 204 through an input of the microfluidic channel 204, or by applying a thermo-capillary motion or an electro-capillary motion into the microfluidic channel 204. For example, the droplet 206 may be formed by connecting a passive pump, or an external device, such as a pressure controller, to the microfluidic channel 204 and by applying the external pressure to the channel 204. Alternatively, in some embodiments, the droplet 206 may be formed by contacting the microfluidic channel 204 to thermal wires such as a resistor and by applying heat to generate thermo-capillary motion in the microfluidic channel 204. Alternatively, in some embodiments, the droplet 206 may be formed by coating the surface of the microfluidic channel 204 with materials having an electrowetting property and by arranging an electrode at a lower and upper ends of the channel to apply the electro-capillary motion into the microfluidic channel 204. In some embodiments, amorphous fluoropolymers may be used the material of the electrowetting property.

In some embodiments, the size and/or speed of the droplet 206 is controlled by controlling the amount of the applied external pressure or thermo-capillary motion or electro-capillary motion.

For example, in response to an applied thermo-capillary motion to the microfluidic channel 204, a temperature difference can be generated within the microfluidic channel 204, thereby dictating the direction that the sample solution flows. As a result, a difference in surface tension between both ends of the droplet 206, which are in contact with the air 205, is generated. Also, the surface tension of liquid decreases as the temperature of the liquid increases. Therefore, the droplet 206 moves toward an area having a lower temperature within the microfluidic channel 204. Alternatively, in response to the voltage applied to the electrode, the hydrophilicity may be changed due to the voltage. As a result, the fluid can flow toward the direction where the voltage is applied.

FIG. 2C illustrates a partial cross section of the microfluidic channel 204 of FIG. 2B, in which a flowing direction of the sample solution is shown. As described above, probes 207 may be patterned on one or more internal walls of the channel 204, for example the internal wall of the silicon wafer 201. As used herein, the internal wall of the microfluidic channel refers to the wall to which the sample solution contacts. The probe may include, but is not limited to, biological molecules such as cDNA, cRNA, mRNA, recombinant DNA, various types of antibodies, etc.

As described with respect to FIGS. 2A and 2B, the solution having a sample 208 flows through the microfluidic channel 204 formed by the glass wafers 201 and 203, and the droplet 206 having the two-phase interface is formed in the microfluidic channel 204. The arrow in FIG. 2C indicates the following direction of the droplet 206. As shown in FIG. 2C, most of the samples 208 are located around the interface of the droplet 206, due to the “coffee-ring” effect. In particular, the sample 208 gathers along the two-phase interface between the solution having the samples 208 and the air 205. Due to the coffee-ring effect, the partial concentration of the sample 208 is increased at a region around the two-phase interfaces.

When the concentration of the samples 208 is high at the two-phase interface of the droplet 206, the likelihood of the association between sample 208 and the probe 207 will be high at the two-phase interface of the droplet 206. As used herein, “association” refers a chemical or biological reaction between the sample 208 and the probe 207. For example, if the sample 208 is an antibody and the probe 207 is an antigen that is specific to the antibody, the “association” refers to the antigen-antibody reaction. Alternatively, the sample 208 and the probe 207 may be complementary sequences, and the association means the binding between the complementary sequences. As used herein, the “likelihood” of the association refers a possibility that the sample can associate with the sample. The likelihood of the association may be quantitatively measured as described below.

In some embodiments, the likelihood of the association may be determined by using an experimental system. The experimental system may have a droplet in a microchannel. The microchannel may be made from a glass pipett with a typical rectangular cross section having a width of about 400 to 1000 μm and a height of about 40 to 100 μm. Since the likelihood of association is determined by the velocity and size of the droplet, the likelihood of association can be determined as a following formula:

U=RΔσ/3 μL,

where U is the mean velocity of the droplet, R is the radius curvature of the droplet meniscus, Δσ is the surface tension difference between the front and rear meniscuses of the droplet, μ is the viscosity of the fluid, and L is the droplet length.

The likelihood of the association between the probe 207 and the sample 208 will be increased in the direction of the flowing direction of the droplet 206. As the flowing speed of the droplet 206 is increased, the likelihood of the association between the sample 208 and the probe 207 will be increased. Thus, the likelihood of the association can be controlled by controlling the flowing speed or size of the droplet 206. The size or the speed of the droplet 206 may be controlled by controlling the speed of the solution following within the microfluidic channel 204 or by controlling the geometry of the microfluidic channel 204. In the present disclosure, the geometry of the microfluidic channel 204 indicates, but is not limited to, a width or a length of the channel 204.

The speed of the droplet 206 may be increased or decreased according to the applied force of external pressure. Alternatively, the thermo-capillary motion may be increased to cause an increase in speed of the flowing of the droplet 206 in the microfluidic channel. In some embodiments, the width of the microfluidic channel may be controlled to control the size or speed of the droplet 206. For example, if the width of the channel is wider, the flowing speed of the solution will be increased. Thus, the speed of the droplet will be increased. Alternatively, as the width of the channel is narrower, the speed of the droplet will be decreased.

In some embodiments, a control means is added to the microfluidic channel to increase the likelihood of association between the sample 208 and the probe 207. For example, the control means (not shown) may be an air injection port connected to the microfluidic channel so as to generate a droplet, or the control means may be a control of the applied thermo-capillary motion or electro-capillary motion. In some embodiments, the control means is a sample solution input port for controlling the flowing speed of sample solution within the microfluidic channel.

FIGS. 2D and 2E are schematic views of a microfluidic channel according to another embodiment. As shown in FIG. 2D, the microfluidic channel may have a T-shape. The T-shaped microfluidic channel may include an input port 209 for delivering a sample solution into the channel and an injection port 210 for providing air into the channel. As a result, the two-phase interface, i.e. the air-liquid interface, can be established in the channel where the sample solution and the air meet.

Alternatively, as shown in FIG. 2E, the microfluidic channel may have a cross-shaped microfluidic channel. The cross-shaped microfluidic channel may have an input port 209 for delivering the sample solution into the channel and two injecting ports 210, each for providing air into the channel. As a result, a two-phase interface can be formed in the channel where the air and the sample solution meet.

In another embodiment, the injection port 210, in FIGS. 2D and 2E, provides oil to the channel. In such embodiments, the resulting water-oil interface is formed where the oil and water meet. The number of the input ports or injection ports may be more than one or two, depending on the desired design. Although not illustrated in the figures, any shape of microfluidic channel may be used for the sample detection, as long as a droplet can be formed in the channel and a two-phase interface can be established in the channel. As described above, the speed or size of the droplet may be controlled by controlling the speed for delivering the sample solution into the channel through the input port 209, or the speed for providing the air or oil into the channel through the injection port 210.

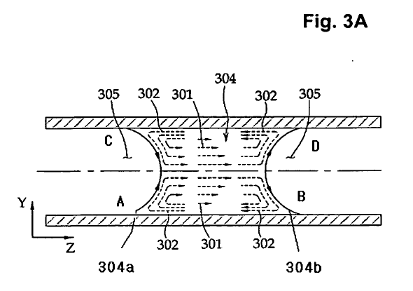

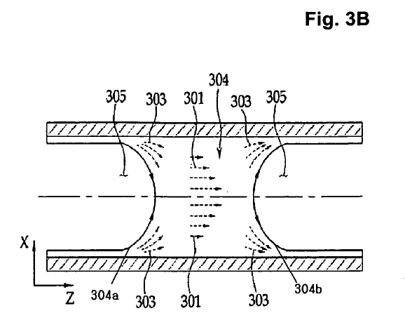

FIGS. 3A and 3B illustrate sectional and top views of a microfluidic channel for illustrating the movement of the samples flowing within the microfluidic channel of FIG. 2B. In FIGS. 3A and 3B, a droplet 304 is formed in a microfluidic channel. The reference numeral 305 indicates air. Alternatively, as described above, oil may be included to form the two-phase interface together with a sample solution. With respect to one surface of the droplet 304, the two-phase interface, such as, air-liquid interface or water-oil interface, is formed. As shown in FIG. 3A, the droplet 304 may be divided into a first area 301 and a second area 302. As used herein, the first area 301 indicates a middle of the droplet 304, and the second area 302 indicates the portions around the two surfaces 304a and 304b of the droplet 304. The two surfaces 304a and 304b of the droplet 304 contact the air 305.

In FIG. 3A, the arrows in each area indicate the direction where samples (shown in FIG. 2C) move within a microfluidic channel. For example, in the first area 301, due to a pressure difference between both surfaces 304a and 304b of the droplet 304, the samples move to the direction indicated by the arrows. Also, in the second area 302, the samples turn along corners A, B, C and D of the two-phase interfaces while moving along the corners in a direction indicated by arrows. The movement in the first area 301 is not influenced by the movement in the second area 302.

If the samples turn along the corners B and D of the two-phase interface, at a front portion in a flowing direction of the both surfaces 304a and 304b of the droplet 304, so as to approach the surface of the microfluidic channel, an adhesive force attracts these samples to a region near the internal wall of the channel.

Thus, the samples are aligned at a region near the surface of the channel due to a shear stress. If the samples turn along the corners A and C of the two-phase interfaces of the droplet 304, at a rear portion in the flowing direction of the both surfaces 304a and 304b of the droplet 304, the samples merge with the flow of samples indicated by arrows in the first area 310. Through repetition of such a flow, samples come together onto the surface of the microfluidic channel and the portion surrounding the interfaces of the droplet 304.

FIG. 3B is a top view of the microfluidic channel for illustrating the movement routes of samples within the microfluidic channel of FIG. 2B. The flow of samples at the first area 301 illustrated in FIG. 3B is the same as the above described flow with reference to FIG. 3A. In another region 303, due to a pressure difference between the droplet 304 and the air 305, a flow of samples is generated along the directions indicated by the arrows.

As shown in FIG. 3B, the samples flow in a direction indicated by the arrows, at a rear portion in the flowing direction of the both surfaces 304a and 304b of the droplet 304, so as to be absorbed into the surface of the microfluidic channel. Also, the samples flow in a direction indicated by arrows, at around a rear portion in the flowing direction of the both surfaces 304a and 304b of the droplet 304 so as to be merged with the flow of the first area 301. Through repetition of such a flow, the samples come together onto the surface of the microfluidic channel and the portion surrounding the interface of the droplet 304.

In some embodiments, as the samples gather near the surface of the microfluidic channel, in the region surrounding the interface of the droplet the concentration of the samples at the region where the samples gather is partially increased. As the sample flows along the microfluidic channel, the likelihood of association between the sample and the probe bound in the micro-array increases. Accordingly, association between the probe and the sample is increased. In some embodiments, association between the probe and the sample has a maximum value at the two-phase interface of the droplet.

In some embodiments, a bio-chip is manufactured according to the sample detecting method. The bio-chip may include, but is not limited to, a DNA chip on which various kinds of DNA are arranged, or a protein chip on which various kinds of antigens or antibodies are bound with different kinds of proteins. For example, a DNA chip or a protein chip may be implemented by assembling the microfluidic device with a glass, plastic, or silicon substrate.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed invention. Additionally the phrase “consisting essentially of” will be understood to include those elements specifically recited and those additional elements that do not materially affect the basic and novel characteristics of the claimed invention. The phrase “consisting of” excludes any element not specifically specified.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for sample detection, comprising:
providing one or more samples to a microfluidic device comprising one or more microfluidic channels, the microfluidic channels comprising:
one or more droplets;
one or more internal walls; and
one or more probes associated with the one or more internal walls; and
controlling the one or more droplets to increase a likelihood of association between the one or more samples and the one or more probes.

2. The method of claim 1, wherein the channel includes at least one two-phase interface with respect to a surface of the droplet.

3. The method of claim 2, wherein the two-phase interface is an air-liquid interface or a water-oil interface.

4. The method of claim 1, wherein the droplet is formed within the microfluidic channel by applying an external pressure into the microfluidic channel or by applying thermo-capillary motion or electro-capillary motion into the microfluidic channel.

5. The method of claim 1, wherein the microfluidic channel is a droplet-based microfluidic channel.

6. The method of claim 1, wherein controlling the droplet includes controlling a size and a speed of the droplet within the microfluidic channel.

7. The method of claim 1, wherein controlling the droplet includes controlling a geometry of the microfluidic channel.

8. The method of claim 1, wherein the microfluidic device further comprises a micro-array deposited on the one or more internal walls, and the micro-array includes the one or more probes.

9. The method of claim 1, wherein the one or more probes are one or more nucleic acids, one or more proteins, or a combination thereof.

10. The method of claim 2, wherein the likelihood of association between the sample and the probe has a maximum value at the two-phase interface.

11. A microfluidic device comprising:
one or more microfluidic channels;
wherein the microfluidic channels comprise one or more internal walls;
one or more droplets; and
one or more probes associated with the one or more internal walls.

12. The microfluidic device of claim 11 further comprising a means for controlling droplet formation within the microfluidic channel to increase the likelihood of association between a sample and the probes.

13. The microfluidic device of claim 12, wherein the mean for controlling controls the droplet formation by applying an external pressure to the microfluidic channel.

14. The microfluidic device of claim 12, further comprising an input, connected to the controlling means, to introduce the sample and to supply air or oil into the microfluidic channel.

15. The microfluidic device of claim 11, wherein the microfluidic channel further comprises a two-phase interface.

16. The microfluidic device of claim 15, wherein the two-phase interface is an air-liquid interface or a water-oil interface.

17. The microfluidic device of claim 11, wherein the microfluidic channel has a T-shape or a cross-shape.

18. The microfluidic device of claim 11, wherein the microfluidic channel further comprises a micro-array deposited on the internal wall, and the micro-array has the probe.

19. A DNA chip comprising the device of claim 11.

20. A protein chip comprising the device of claim 11.
